(19) United States
(12) Patent Application Publication
(10) Pub. No.: US 2013/0168999 A1
(43) Pub. Date: Jul. 4, 2013

(54) VEHICLE AIRSTREAM DEFLECTOR AND RELATED METHOD

(71) Applicant: David Hitchcock, Redlands, CA (US)

(72) Inventor: David Hitchcock, Redlands, CA (US)

(21) Appl. No.: 13/342,802

(22) Filed: Jan. 3, 2012

(51) Int. Cl. B62D 35/00

(52) U.S. Cl. 296/180.1

(57) ABSTRACT

A vehicle airstream deflector is provided. The deflector provides an air curtain to divert oncoming air flow past the passenger cabin of a vehicle, thereby reducing drag. Furthermore, air flow from the rear of the vehicle is induced to move forward, providing additional vehicle momentum in the direction of travel.

### BACKGROUND OF THE INVENTION

1. Field of the Invention

The invention relates in general to drag reduction on a vehicle and, more particularly, to a vehicle airstream deflector and method that provide an air curtain to deflect oncoming air flow for vehicles for reducing vehicular drag.

2. Description of the Related Art

In fluid dynamics, drag (sometimes called air resistance or fluid resistance) refers to forces that oppose the relative motion of an object through a fluid (a liquid or gas). For a moving vehicle, a drag force is imparted on a vehicle as it moves and interacts with the air, and this drag force acts in a direction substantially opposite the direction of travel. This drag resistive force is given by the following relation:

F_{d}=½ρv²AC_{d}

where, ρ is the density of air, v is the vehicle velocity, A is the frontal surface area of the vehicle, and C_{d} is the drag coefficient.

Since the drag force increases as the square of velocity, a low drag coefficient is desirable. For cars, the drag coefficient is typically in the range from about 0.25 to about 0.50.

Conventional technologies to reduce the drag coefficient include mechanical aerodynamic control devices. These have several drawbacks and disadvantages. For instance, undesirably, these mechanical devices are limited in their effectiveness since the drag force is highly sensitive to the velocity, due to the dynamic pressure (½ρv²A) of a moving flow of gas on the vehicle being proportional to the vehicle velocity squared, and as such dramatically increases as velocity is increased.

### SUMMARY OF THE INVENTION

In some embodiments, a vehicle airstream deflector is provided. Advantageously, the deflector provides an air curtain to divert oncoming air flow past the passenger cabin of a vehicle, thereby reducing drag. Furthermore, and desirably, air flow from the rear of the vehicle is induced to move forward, providing additional vehicle momentum in the direction of travel.

In some embodiments, a vehicle airstream deflector is provided to reduce drag on the vehicle, by diverting the volume of air that would otherwise or normally impact a front windshield of the vehicle, in the vehicle's forward velocity vector or motion. The vehicle drag is reduced by substantially blocking the momentum exchange between an upper body of the moving vehicle, primarily the front windshield, and impacting air or gas molecules in the direction of travel. The deflector utilizes an air jet that is blown substantially vertically upward, generally at a right angle to the vehicle direction of travel, such that air jet intersects and directs air or gas molecules out of the path of the approaching vehicle, and as such forming a barrier sufficient to reduce vehicle drag. The air or gas deflection is principally upward and over a passenger cabin of the vehicle. To generate this air jet, forced air or gas is blown through a conduit in an engine compartment of the vehicle and ejected upward through a generally transversely elongated slit or slot disposed forwardly of the front windshield.

In some embodiments, a vehicle having a forward end or portion comprises an airstream deflector. The deflector includes a source of air or gas under a predetermined pressure and a conduit to project the air or gas from the vehicle forward end or portion with sufficient flow to form an upward generally vertical air jet configured for drag reduction. This arrangement, without being bound to any limitations, can be thought of as being similar to air knifes used in blow off operations in various factory settings. These air knifes entrain the surrounding air to produce total airflows that range from 25 to 50 times the amount of supplied compressed air.

Another beneficial result, in some embodiments, of the operation and implementation of a generally upward vertical air jet is that the air or gas from a rear end or portion of the vehicle is induced to move forward because of a reduced or low pressure area or region created behind and between the air jet and the front windshield forwardly of the windshield. The forward air stream forces compensating air to flow in a forward direction, thereby, and advantageously, providing an additional push or force to the vehicle in the direction of travel. This effect, without being bound to any limitations, can be contemplated as being akin to a low pressure area formed behind the windshield of a convertible, such that, air moves forward resulting in the driver's hair being blown in the direction of travel. Also, this effect, and again without being bound to any limitations, can be observed on a motorcycle rider as his/her body blocks the forward air and a low pressure region forms behind the rider, thereby resulting in the rider's shirt, blouse or top being forced upward from behind.

In accordance with some embodiments, a vehicle with a forward end is provided. The forward end includes a conduit having a source of air under pressure. The vehicle and/or forward end includes an outlet operable to project a jet of air in a direction substantially perpendicular to and away from a support surface on which the vehicle is moving with sufficient flow and direction to advantageously form a barrier sufficient to reduce vehicle drag.

In one embodiment, the source comprises a fan in a compartment of the vehicle.

In one embodiment, the conduit generally extends from the source to the outlet.

In one embodiment, the barrier is at least partially above the forward end of the vehicle.

In one embodiment, the jet of air is configured such that a reduced pressure region is created at the forward end of the vehicle so that a forward flow is created to impart forward thrust to the vehicle.

In accordance with some embodiments, a vehicle is provided. The vehicle generally comprises a front portion and a front windshield. The front portion includes a compartment. The front windshield is located rearwardly relative to the front portion. The vehicle comprises a pressurized gas source in the compartment of the front portion, a conduit in the compartment of the front portion that is in fluid communication with the pressurized gas source, and an outlet proximate to and located forwardly relative to the front windshield and at an upper portion of the front portion. The outlet is in fluid communication with the conduit. Advantageously, at least the pressurized gas source is operable to provide a gas jet of a predetermined velocity through the outlet to interact with an oncoming gas flow as the vehicle moves and deflect the oncoming gas flow in front of the front windshield such that drag force on the vehicle is reduced.

In one embodiment, the gas jet is emitted through the outlet in a generally perpendicular and/or upward direction relative to a support surface on which the vehicle is travelling.

In one embodiment, the outlet comprises a generally elongated slot that extends in a transverse direction.

In one embodiment, the interaction of the gas jet with the oncoming gas flow is configured to provide a pressure differential between the front windshield and a rear portion of the vehicle so as to impart a forward push to the vehicle.

In one embodiment, the vehicle further comprises a controller to control at least the operation of the pressurized gas source.

In accordance with some embodiments, a vehicle airstream deflector is provided. The deflector generally comprises a source of pressurized air, an outlet, and a conduit. The source of pressurized air is disposed in a front compartment of a vehicle. The outlet is located generally above the front compartment and forward of a front windshield of the vehicle. The conduit is in the front compartment and provides fluid communication between the source of pressurized air and the outlet. Advantageously, the deflector is operable to project a jet of air through the outlet in front of the front windshield to form a barrier sufficient to reduce drag on the vehicle.

In one embodiment, the jet of air interacts with an incoming airstream to deflect the incoming airstream over the front windshield.

In one embodiment, the jet of air is configured to provide a low pressure region in front of the front windshield so as to induce a forward airstream that provides a forward vehicular thrust.

In one embodiment, the conduit has a generally tapered profile.

In one embodiment, the jet of air is configured to deflect an incoming air stream such that the deflected airstream travels over an upper body of the vehicle.

In accordance with some embodiments, a method of reducing vehicular drag is provided. The method generally comprises providing pressurized gas from a front compartment of a vehicle to an outlet proximate and forward to a front windshield of the vehicle. The fluid dynamics of a gas jet formed, through the outlet, in front of the front windshield are controlled by adjusting gas flow. An oncoming airstream directed towards the front windshield by the gas jet is deflected so that the deflected airstream substantially flows over the vehicle.

In one embodiment, a second airstream is induced that flows in a direction substantially opposed to the deflected airstream and provides a forward thrust to the vehicle.

In one embodiment, the velocity and/or direction of the gas jet in response to vehicular velocity is/are controlled.

In one embodiment, the deflected airstream flows over a passenger cabin of the vehicle.

In one embodiment, the gas jet forms a barrier between the oncoming airstream and the front windshield.

For purposes of summarizing the invention, certain aspects, advantages and novel features of the invention have been described herein above. Of course, it is to be understood that not necessarily all such advantages may be achieved in accordance with any particular embodiment of the invention. Thus, the invention may be embodied or carried out in a manner that achieves or optimizes one advantage or group of advantages as taught or suggested herein without necessarily achieving other advantages as may be taught or suggested herein.

All of these embodiments are intended to be within the scope of the invention herein disclosed. These and other embodiments of the invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

Having thus summarized the general nature of the invention and some of its features and advantages, certain preferred embodiments and modifications thereof will become apparent to those skilled in the art from the detailed description herein having reference to the figures that follow, of which:

FIG. 1 is a simplified schematic side, and partially cutaway or sectional, view of a vehicle with a vehicle airstream deflector illustrating features and advantages in accordance with certain embodiments of the invention.

FIG. 2 is a simplified schematic side, and partially cutaway or sectional, partial view of the vehicle of FIG. 1 showing diversion of air flow caused by a vertical air jet of the deflector and induced forward flow from a rear portion of the vehicle illustrating features and advantages in accordance with certain embodiments of the invention.

FIG. 3 is a simplified schematic side, and partially cutaway or sectional, view of a front portion of the vehicle of FIG. 1 showing pressurized air source arrangements illustrating features and advantages in accordance with certain embodiments of the invention.

FIG. 4 is a simplified schematic top, and partially cutaway or sectional, view of FIG. 3 illustrating features and advantages in accordance with certain embodiments of the invention.

### DETAILED DESCRIPTION OF THE PREFERRED EMBODIMENTS

The preferred embodiments of the invention described herein relate generally to drag reduction on a vehicle and, in particular, to a vehicle airstream deflector and method that provide an air curtain to deflect oncoming air flow for vehicles for reducing vehicular drag, and which in at least some arrangements, provide a forward thrust to the vehicle.

While the description sets forth various embodiment specific details, it will be appreciated that the description is illustrative only and should not be construed in any way as limiting the invention. Furthermore, various applications of the invention, and modifications thereto, which may occur to those who are skilled in the art, are also encompassed by the general concepts described herein.

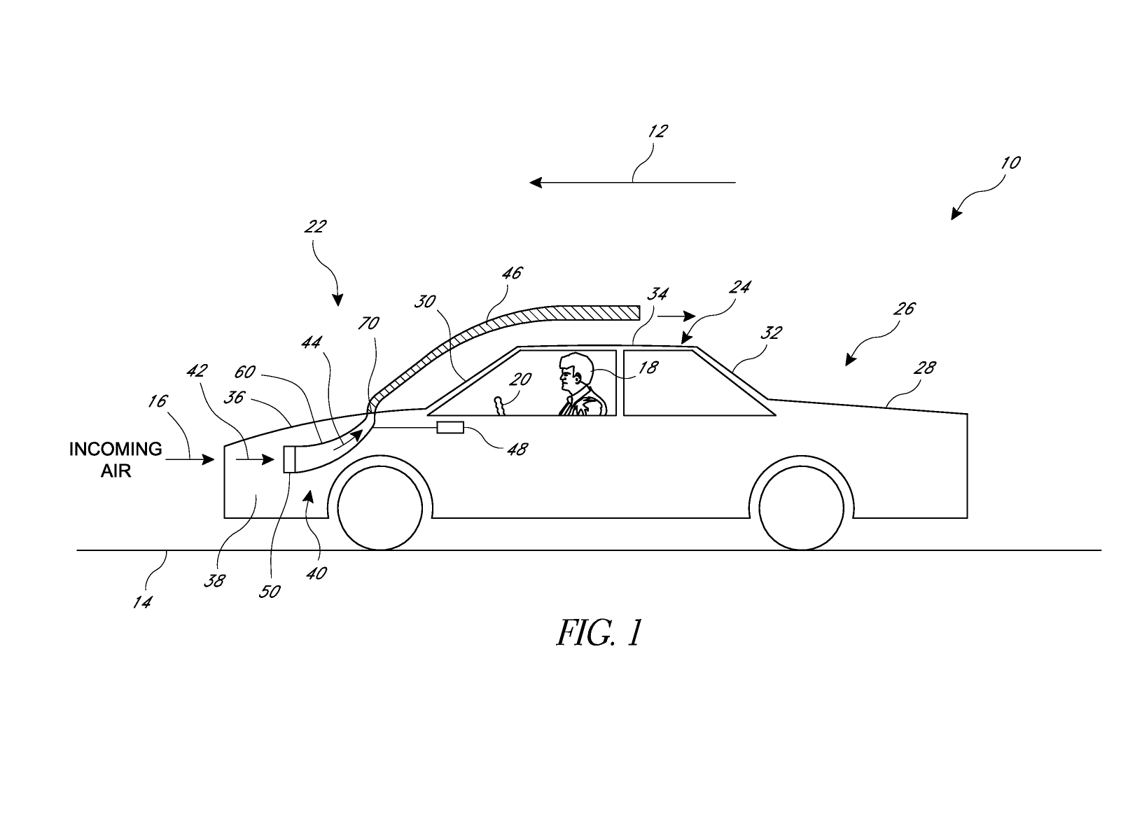

FIG. 1 depicts a vehicle 10 that in accordance with some embodiments provides a unique approach to reducing vehicular drag. The vehicle 10 moves in a direction as generally depicted by arrow 12 on a support surface 14, such as, but not limited to, a roadway. Relative motion of air or gas with respect to the moving vehicle 10 results in an incoming air or gas flow 16. A driver or passenger 18 navigates the vehicle 10 generally by manipulating a steering wheel 20.

The vehicle 10 generally comprises a forward or front portion or end 22, an intermediate passenger cabin or upper body portion 24, and a rear portion or end 26. The rear portion 26 can include a trunk 28 or the like. However, the drag reduction embodiments of the invention are efficaciously applicable to a vehicle without a conventional sedan trunk, such as, a hatchback vehicle, a truck with a rear bed, a trailer, a bus or lorry, an SUV or SAV, hybrid vehicles, electric vehicles or the like, among others.

The intermediate passenger cabin 24 generally comprises a front or forward windshield 30, a rear windshield 32, an intermediate top or upper roof 34 and the passenger compartment. The forward or front portion or end 22 can generally comprise a hood 36 and a compartment 38 such as an engine compartment.

A novel vehicle airstream deflector apparatus, system or assembly 40 is located, disposed, or positioned at least partially within the compartment 38, and which in operation advantageously provides an immense reduction in vehicular drag, desirably coupled with, at least in some embodiments, a forward vehicular thrust. Incoming air or gas flow 16 enters the vehicle forward portion 22 as upstream flow 42. This flow 42 interacts with an air or gas pressurizing source 50, such as a fan, pump, blower or the like, among others, and as discussed in further detail below.

The downstream pressurized air or gas 44 travels through a conduit, passage or channel 60 having a predetermined configuration and emanates through a generally transversely elongated slot, slit, slots or slits, ports, orifices, outlets, or combinations thereof 70 as an air or gas deflection jet 46 that is ejected through the slot 70 in a generally vertical direction or in a direction generally perpendicular to the support surface 14. The conduit 60 can have a tapered profile, for example, with higher dimensions proximate to the source 50 and lower dimensions proximate to the slot 70. Also, it should be appreciated that the gas deflection jet 46 contributes to forming a barrier sufficient to reduce vehicle drag.

As discussed further below, a control system, controller 48 or the like may be utilized in some embodiments to control the operation of the vehicle airstream deflector apparatus, system or assembly 40 to provide for optimized drag reduction and fuel or energy consumption.

The transversally extending slot 70 can be dimensioned and configured in various manners, given due consideration to achieving the goals of vehicular drag reduction and fuel efficiency. For example, but not limited to, the slot 70 may have a width of in the order of about 1 cm to about tens of centimeters. In modified embodiments, the slot structure can comprise other dimensions and/or configurations with efficacy, as needed or desired.

It should be appreciated that even though, in general, the drawings and description refer to an incoming air flow or stream, it is the vehicle 10 that is travelling at a certain velocity, and air flows and streams are relative to a virtual stationary vehicle for purposes of illustration. Stated differently, the fluid dynamics relate to relative motion between the vehicle 10 and the air flow and/or stream interaction. However, it is to be understood that the drag reduction fluid dynamic approaches presented herein are not only applicable to generally calm wind conditions, wherein the vehicle velocity dominates, but can also be efficaciously adapted for high wind or extreme weather conditions, wherein a vehicle control system or controller, including various sensors, can be optimized for a particular air flow profile to provide for a desired or required drag reduction.

Though the support surface 14 has been shown to be generally horizontal, it should be appreciated that the embodiments of the invention are efficaciously applicable to a wide variety of terrains. For instance, inclined surfaces wherein the vehicle 10 can be travelling uphill or downhill. In these cases, the deflection jet 46 can be oriented substantially perpendicularly to the support surface 14 and not necessarily vertical.

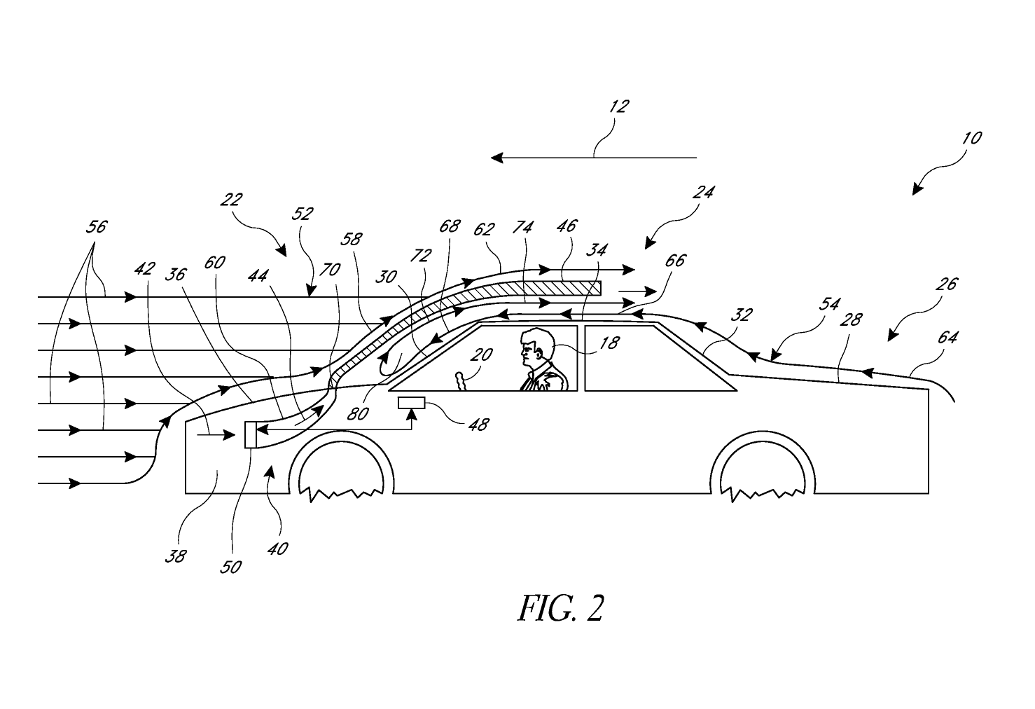

Turning now to FIG. 2, in accordance with some embodiments, the vehicle 10 travels in an incoming airstream 52, with a vehicle provided generally vertical (or substantially perpendicular to the support surface) deflection jet 46 that extends from a hood position or front portion of the vehicle and is generally located forwardly of the front windshield 30. The incoming airstream 52 impacts, interacts or fluidly communicates with the deflection jet 46 such that both the jet 46 and airstream 52 are bent, curved or arced in a generally backwards direction by the dynamic pressure of the incoming airstream 52. Additionally, and advantageously, a forward airstream 54 is induced because of a low pressure area or region 80 formed between the air deflection jet 46 and the front windshield 30.

The incoming airstream 52 comprises an airstream 56 that is deflected by the jet 46 to form an airstream 58 that travels over the front windshield 30 and over the roof 34 of the passenger cabin 24 as airstream 62. This unique streamlined configuration and arrangement has multiple advantages and benefits as discussed herein. Stated differently, or in other words, the deflection jet 46 forms a barrier sufficient to reduce vehicle drag.

The deflector 40 is not a mechanical structure in the sense of a conventional airdam. As such, the detrimental velocity effects of conventional devices relating to vehicular drag are, if not eliminated, but substantially reduced or mitigated.

Moreover, embodiments of the invention, such as the deflector 40 can be fine tuned as to provide optimized vehicular performance in terms of drag reduction, among others. For example, the vehicle 10 can be configured to customize the velocity and arrangement of the deflection jet 46 based on the velocity of the vehicle 10. This may be accomplished, for example, by a control and monitoring system employing sensors, such as the system 48, to optimize drag reduction and energy efficiency. Thus, at higher vehicle speeds, the deflection jet 46 can have a higher velocity and/or the deflector 40 can be configured, as needed or desired.

It is contemplated that the embodiments disclosed herein remedy and improve on conventional drag reduction devices. For example, the deflection jet 46 can in a virtual model lower the impact of the vehicle velocity, thereby reducing drag. Moreover, the deflection jet 46 substantially eliminates or mitigates the frontal drag area, at least in a virtual model, on the front windshield 30.

With respect to the forward airstream 54, this is one further benefit of the vehicle airstream deflector 40. Given the deflection jet 46, this creates a low pressure area, space or region 80 forward of the front windshield 30 and induces a flow 54 in the direction of vehicle travel 12, to provide a further forwardly oriented thrust or push in the direction of travel 12.

This gas or airstream 54 generally emanates from the vehicle rear portion 26 as flow 64, travels over the passenger cabin 24 and roof 34 as flow 66, and over the front windshield 30 as flow 68. Then, at least partially due to the deflection jet 46 and the low pressure region 80 air flows backwards as depicted by arrows 72 and 74.

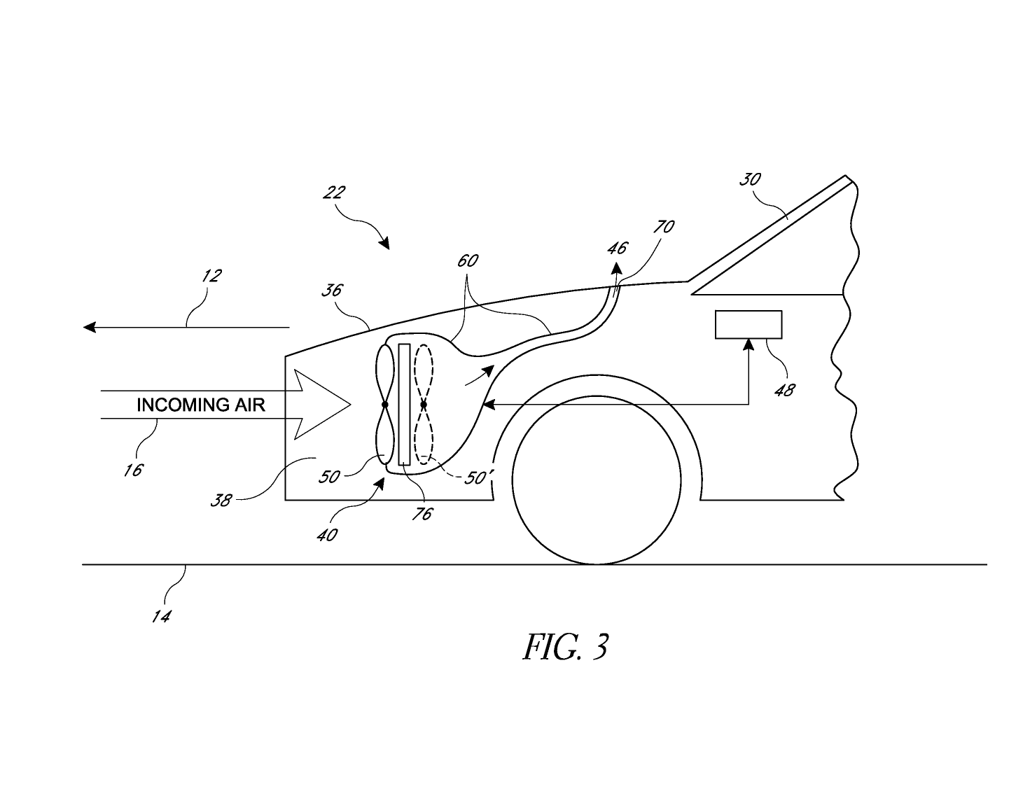

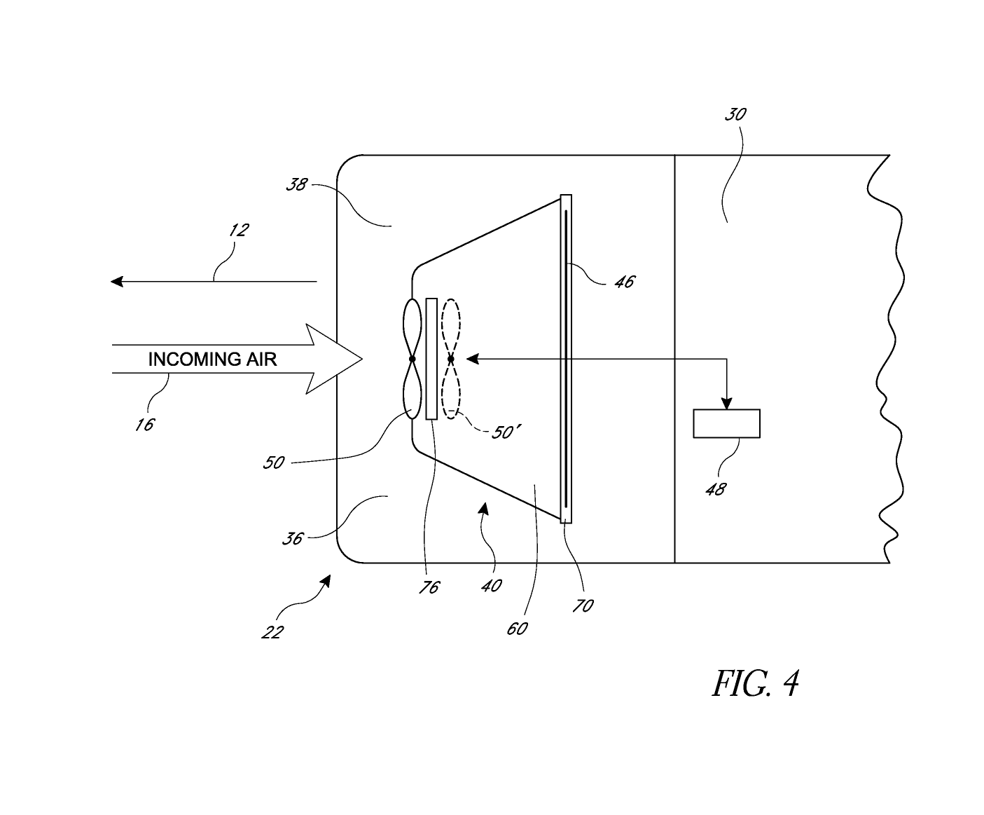

FIGS. 3 and 4 are illustrative embodiments showing pressurized air source arrangements. These drawings show a radiator 76 in the engine compartment 38. A fan or blower 50 spaced forwardly from the radiator 76 can be the source of pressurized air. Alternatively, a fan or blower 50′ spaced rearwardly from the radiator 76 can be the source of pressurized air, for example, if the vehicle airstream deflector is utilized in conjunction with a fuel cell vehicle. The radiator 76 and/or fans 50 or 50′ can be efficaciously angulated, as desired or required. Also, the source of pressurized gas or air can be an independent unit within the vehicle independent of the any radiator fans, as desired or required.

With respect to the control system 48, it can be adapted to recognize the velocity of the vehicle 10. And as such, can control the flow of air through the slot 70 to optimize drag reduction. In some embodiments, this would be done automatically. In other embodiments, the driver or passenger may have some control in actuating or adjusting the operation of the deflector 40, for example, via buttons on the dashboard and/or steering wheel. In further embodiments, the entire control of the air deflector 40 can be manually controlled by the driver.

The components of the deflector 40 which provide an air curtain or barrier to relative oncoming flow can comprise a wide variety of materials. For example, plastics, thermoplastics, metals, alloys, ceramics, among others, as desired or required.

One aspect of embodiments of the invention can relate to an optimized balance between drag reduction and engine cooling requirements. For example, the functionality of the air pressurizing source 50 can be operatively coupled to the heat generated in the engine compartment 38. The controller 48 can be employed in this operational procedure.

Any methods which are described and illustrated herein are not limited to the sequence of acts described, nor are they necessarily limited to the practice of all of the acts set forth. Other sequences of acts, or less than all of the acts, or simultaneous occurrence of the acts, may be utilized in practicing embodiments of the invention.

It is to be understood that any range of values disclosed, taught or suggested herein comprises all values and sub-ranges therebetween. For example, a range from 5 to 10 will comprise all numerical values between 5 and 10 and all sub-ranges between 5 and 10.

From the foregoing description, it will be appreciated that novel approaches for vehicular drag reduction, forward vehicular thrust, and performance efficiency have been disclosed. While the components, techniques and aspects of the invention have been described with a certain degree of particularity, it is manifest that many changes may be made in the specific designs, constructions and methodology herein above described without departing from the spirit and scope of this disclosure.

While a number of preferred embodiments of the invention and variations thereof have been described in detail, other modifications and methods of using, and drag reduction and thrust providing applications for the same will be apparent to those of skill in the art. Accordingly, it should be understood that various applications, modifications, and substitutions may be made of equivalents without departing from the spirit of the invention or the scope of the claims.

Various modifications and applications of the invention may occur to those who are skilled in the art, without departing from the true spirit or scope of the invention. It should be understood that the invention is not limited to the embodiments set forth herein for purposes of exemplification, but is to be defined only by a fair reading of the appended claims, including the full range of equivalency to which each element thereof is entitled.

What is claimed is:

1. A vehicle having a forward end including a conduit having a source of air under pressure and including an outlet operable to project a jet of air in a direction substantially perpendicular to and away from a support surface on which the vehicle is moving with sufficient flow and direction to form a barrier sufficient to reduce vehicle drag.

2. The vehicle of claim 1, wherein the source comprises a fan in a compartment of the vehicle.

3. The vehicle of claim 1, wherein the conduit generally extends from the source to the outlet.

4. The vehicle of claim 1, wherein the barrier is at least partially above the forward end of the vehicle.

5. The vehicle of claim 1, wherein the jet of air is configured such that a reduced pressure region is created at the forward end of the vehicle so that a forward flow is created to impart forward thrust to the vehicle.

6. A vehicle, comprising:
a front portion including a compartment;
a front windshield located rearwardly relative to the front portion;
a pressurized gas source in the compartment of the front portion;
a conduit in the compartment of the front portion and being in fluid communication with the pressurized gas source; and
an outlet proximate to and located forwardly relative to the front windshield and at an upper portion of the front portion, the outlet being in fluid communication with the conduit;
wherein at least the pressurized gas source is operable to provide a gas jet of a predetermined velocity through the outlet to interact with an oncoming gas flow as the vehicle moves and deflect the oncoming gas flow in front of the front windshield such that drag force on the vehicle is reduced.

7. The vehicle of claim 6, wherein the gas jet is emitted through the outlet in a generally perpendicular and/or upward direction relative to a support surface on which the vehicle is travelling.

8. The vehicle of claim 6, wherein the outlet comprises a generally elongated slot that extends in a transverse direction.

9. The vehicle of claim 6, wherein the interaction of the gas jet with the oncoming gas flow is configured to provide a pressure differential between the front windshield and a rear portion of the vehicle so as to impart a forward push to the vehicle.

10. The vehicle of claim 6, wherein the vehicle further comprises a controller to control at least the operation of the pressurized gas source.

11. A vehicle airstream deflector, comprising:
a source of pressurized air disposed in a front compartment of a vehicle;
an outlet being located generally above the front compartment and forward of a front windshield of the vehicle; and
a conduit in the front compartment and providing fluid communication between the source of pressurized air and the outlet;
the deflector being operable to project a jet of air through the outlet in front of the front windshield to form a barrier sufficient to reduce drag on the vehicle.

12. The deflector of claim 11, wherein the jet of air interacts with an incoming airstream to deflect the incoming airstream over the front windshield.

13. The deflector of claim 11, wherein the jet of air is configured to provide a low pressure region in front of the front windshield so as to induce a forward airstream that provides a forward vehicular thrust.

14. The deflector of claim 11, wherein the conduit has a generally tapered profile.

15. The deflector of claim 11, wherein the jet of air is configured to deflect an incoming air stream such that the deflected airstream travels over an upper body of the vehicle.

16. A method of reducing vehicular drag, comprising:
providing pressurized gas from a front compartment of a vehicle to an outlet proximate and forward to a front windshield of the vehicle;
controlling the fluid dynamics of a gas jet formed, through the outlet, in front of the front windshield by adjusting gas flow; and
deflecting an oncoming airstream directed towards the front windshield by the gas jet so that the deflected airstream substantially flows over the vehicle.

17. The method of claim 16, wherein the method further comprises inducing a second airstream that flows in a direction substantially opposed to the deflected airstream and provides a forward thrust to the vehicle.

18. The method of claim 16, wherein the method further comprises controlling the velocity and/or direction of the gas jet in response to vehicular velocity.

19. The method of claim 16, wherein the deflected airstream flows over a passenger cabin of the vehicle.

20. The method of claim 16, wherein the gas jet forms a barrier between the oncoming airstream and the front windshield.
